(19) United States
(12) Patent Application Publication
(10) Pub. No.: US 2021/0066706 A1
(43) Pub. Date: Mar. 4, 2021

(54) HIGH-ENERGY RECHARGEABLE AL-CO2 BATTERY FOR CO2 CAPTURE/CONVERSION AND ELECTRIC POWER GENERATION/STORAGE

(71) Applicant: MASSACHUSETTS INSTITUTE OF TECHNOLOGY, Cambridge, MA (US)

(72) Inventors: Angela Belcher, Lexington, MA (US); Jifa Qi, West Roxbury, MA (US); Shuya Wei, Brighton, MA (US)

(73) Assignee: MASSACHUSETTS INSTITUTE OF TECHNOLOGY, Cambridge, MA (US)

(21) Appl. No.: 17/003,819

(22) Filed: Aug. 26, 2020

Related U.S. Application Data
(60) Provisional application No. 62/891,910, filed on Aug. 26, 2019.

(51) Int. Cl. H01M 4/131; H01M 4/46; H01M 4/583

(52) U.S. Cl. CPC H01M 4/131; H01M 4/583; H01M 4/463

(57) ABSTRACT

A metal-carbon dioxide battery can include an aluminum-containing anode and a carbon-containing cathode.

### CLAIM OF PRIORITY

This application claims priority to U.S. Provisional Patent Application No. 62/891,910, filed Aug. 26, 2019, which is incorporated by reference in its entirety.

### FEDERAL SUPPORT STATEMENT

This invention was made with Government support under Grant No. HR0011-15-C-0084 awarded by the Defense Advanced Research Projects Agency (DARPA). The Government has certain rights in the invention.

### TECHNICAL FIELD

This invention relates to carbon dioxide and electric power storage and generation.

### BACKGROUND

Since the Industrial Revolution, the increasing energy demand based on fossil fuels substantially impart carbon dioxide level in the atmosphere, leading to abnormal and extreme climate changes. It has been reported that, in 2018, energy-related CO₂ emission rose 1.7% to a historic high of 33.1 Gt CO₂. Very recently, CO₂ in the atmosphere eclipsed 415 ppm for the first time in human history. Therefore, developing reliable technologies to incorporating carbon capture, utilization and sequestration with high energy density of fossil fuels are one of the most urgent and challenging necessities in the era. Significant efforts have been devoted for carbon capture technologies based on aqueous amine-based solutions, and CO₂ reduction technologies to fuels or chemicals by chemical, photochemical or electrochemical processes. However, the large energy inputs are required in these post-combustion carbon capture and conversion technologies. For examples, electrochemically converting CO₂ to CH₄ with metal catalyst such as Cu in aqueous solution requires surprisingly high overpotential above 1 V, with yields of ˜20%. Even the simplest conversion product CO, via two-electron transfer, can only be formed at overpotentials of 0.5 V-1 V with acceptable Faradaic efficiencies less than 50% with competing H₂ by-product evolution cooccurring during the process. It is understood that conversion of CO₂ to useful fuels and chemicals is very difficult because of the high thermodynamic and kinetic stability of CO₂. Therefore, developing low energy carbon capture and conversion technologies is still one of the priorities for researchers and scientists to mitigate global climate change.

### SUMMARY

In one aspect, a battery can include a housing including a cathode including a carbon material, an anode including a metal, a separator between the cathode and the anode, and an electrolyte contacting the anode and the cathode, the electrolyte including a redox mediator.

In another aspect, a method of sequestering carbon dioxide can include applying a voltage across an anode and a cathode, the anode including a metal, the cathode including a carbon material, and an electrolyte including a redox mediator in contact with the anode and the cathode, in the presence of carbon dioxide to produce a reduced carbon dioxide material.

In another aspect, a method of providing electric power can include providing a battery comprising a housing containing a cathode including a carbon material, an anode including a metal, a separator between the cathode and the anode; and an electrolyte contacting the anode and the cathode, the electrolyte including a redox mediator, and discharging the battery. The method can include recharging the battery. In certain circumstances, the method can include providing carbon dioxide to the battery.

In certain circumstances, the housing can include one or more ports for entry and exit of a gas. In certain circumstances, the housing can include an anode gas entry port, an anode gas exit port, an electrolyte entry port and an electrolyte exit port. In certain circumstances, an electrolyte reservoir can be fluidly connected to the electrolyte entry port and the electrolyte exit port.

In certain circumstances, the metal can include sodium, magnesium, aluminum, zinc, calcium, copper or iron.

In certain circumstances, the carbon material can include a conductive carbon material. In certain circumstances, the conductive carbon material includes graphene, graphite, carbon black, carbon fibers, carbon microfibers, carbon nanomaterials, carbon nanotubes, multi-walled nanotube carbon, single walled carbon nanotubes, biotemplated carbon materials, molecular templated multi-walled nanotube carbon or biotemplated single walled carbon nanotubes.

In certain circumstances, the electrolyte can include an organic salt.

In certain circumstances, the redox mediator can include an iodide salt or a bromide salt, for example, aluminum iodide or aluminum bromide.

In certain circumstances, the battery can reduce at least a portion of CO₂.

In certain circumstances, the battery can have a capacity of greater than 7000 mAh/g, greater than 8000 mAh/g, or greater than 9000 mAh/g.

In certain circumstances, the battery can have an energy density of greater than 4 Wh/g, greater than 64 Wh/g, greater than 8 Wh/g, or greater than 9 Wh/g.

In certain circumstances, the anode can include aluminum and the redox mediator can include an iodide salt.

In certain circumstances, the battery can have an energy efficiency of greater than 90%, or greater than 95%.

In certain circumstances, the battery can be rechargeable.

In certain circumstances, the battery can be a flow through battery.

Other aspects, embodiments, and features will be apparent from the following description, the drawings, and the claims.

### BRIEF DESCRIPTION OF THE DRAWINGS

FIG. 1A shows an architecture of a secondary Al—CO₂ electrochemical cell.

FIG. 1B shows a schematic of a metal-air battery.

FIGS. 2A-2D show electrochemical performance of secondary Al—CO₂ batteries using molecular templated MWNT carbon (RFN-MWNT) as the cathode.

FIGS. 3A-3E show electrochemical studies of ionic liquid electrolytes in Al batteries.

FIGS. 4A-4D show reaction mechanism of Al—CO₂ batteries in ionic liquid electrolytes.

FIG. 5 shows further data for Al—CO₂ batteries.

FIG. 6 shows a TEM image of templated resorcinol-formaldehyde materials.

FIG. 7 shows a TEM image of bio-templated carbon nanofibers.

FIG. 8 shows high resolution TEM images of bio-templated carbon nanofibers including nickel.

FIG. 9 shows XRD patterns of bio-templated carbon nanofibers including nickel.

FIG. 10 shows Raman spectra of bio-templated carbon nanofibers including nickel and bio-templated carbon nanofibers.

FIG. 11 shows the first discharge performance of Al—CO₂ battery when filled with different concentration of CO₂.

FIG. 12 shows the first discharge performance of Al—CO₂ battery with refilling with CO₂.

FIG. 13 show voltage of an Al-Air battery.

FIG. 14 shows a flow battery.

### DETAILED DESCRIPTION

In recent years, the metal/CO₂ electrochemical cell has been demonstrated as a novel approach to capture CO₂ from mixed CO₂/O₂ gas streams and generating electricity, particularly using highly energetic metallic Li, Na, Mg and Al anodes. The utilization of CO₂ in electrochemical energy storage devices provides a promising clean strategy for reducing fossil fuel consumption and consequently, lessening global warming, as well as a potential energy sources for scientific exploration and future immigration to Mars, for the air there contains 95% of CO₂. Aluminum (Al) is the most abundant metal in the earth's crust and much less reactive than alkali metals such as lithium and sodium. Aluminum participates in a three-electron process during electrochemical charge/discharge reactions, which gives its attractive gravimetric capacity (2980 Ah kg⁻¹) and also competitive volumetric capacity (804 Ah cm⁻³) compared to single-electron lithium (3862 Ah kg⁻¹) and sodium (1166 Ah kg⁻¹) redox reactions. A rechargeable battery based on aluminum ion is also advantageous in perspectives of cost-effectiveness, manufacturability (the lower reactivity of Al requires less stringent control of O₂ and moisture during cell fabrication) and safety handling. Among these studies, Sadat and Archer developed an O₂-assisted Al—CO₂ electrochemical cell for CO₂ capture/conversion and electric power generation. This type of batteries composed of an aluminum metal anode, a carbon cathode and an acidic non-aqueous ionic liquid melt electrolyte. This electrolyte contains aluminum chloride and 1-ethyl-3-methylimidizalium chloride, where CO₂ can be reduced to aluminum oxalate in acidic solutions.

One of the important findings is that the presence of O₂ is important to enable the chemical reduction and thereby the capture of CO₂ by forming superoxide intermediates. Since superoxide is chemically unstable, it could only effectively sequester CO₂ in primary battery configuration, however, the reverse charge process could be very difficult to achieve. This inspires the development of rechargeable Al—CO₂ batteries by replacing O₂ with stable redox mediators in the electrolyte. AlI₃ is a redox mediator that has been used to facilitate electrochemical reduction and oxidation of various batteries like Li—O₂, Li—S and so on, by facilizing electron transport for these insulating molecules and lowering the over potential. It was shown to be able to absorb and reduce CO₂ at the M06-2X(SCRF) level, and subsequently release CO via forming a phosphonium acryl halide intermediate. Moreover, the reduction rate of different halide follows I⁻>Br⁻>Cl⁻, indicating adding iodide species in the Al—CO₂ batteries could probably enhance CO₂ reduction without the assistance of O₂. Furthermore, the presence of Cl⁻, Br⁻, and I⁻ was found to lower the overpotential and to increase the CO₂ electroreduction rate on plasma-activated preoxidized Cu catalyst in the order I⁻>Br⁻>Cl⁻, without sacrificing their intrinsically high C2-C3 product selectivity (˜65% total Faradaic efficiency at −1.0 V vs RHE). Based on these studies, we hypothesis that if we alter the halide anions in the ionic liquid melts for Al—CO₂ batteries, we could probably be able to enhance the efficiency of CO₂ reduction in the electrochemical reaction.

Aluminum-carbon dioxide batteries are described, for example, in U.S. Pat. No. 10,026,958, Al Sadat and Archer, Sci. Adv. 2016; 2:e1600968, and Ma, Adv. Mater. 2018, 30, 1801152, each of which is incorporated by reference in its entirety.

Electrochemical systems, electrodes, and compositions can include a redox mediator. In some cases, the redox mediator can include iodide or bromide. The systems can operate with improved activity, e.g., at low absolute value of the overpotential, high current density, significant efficiency, stability, or a combination of these. The systems also can operate at or higher than neutral pH, without necessarily requiring highly pure solvent sources, or any combination. The systems, electrodes, systems, and compositions are useful in applications such as energy storage, energy use, and carbon sequestration.

Electrolytic devices, fuel cells, and metal-air batteries are non-limiting examples of electrochemical devices provided herein. Energy can be supplied to electrolytic devices, in a charging mode, by a power source. A power source may supply DC or AC voltage in an electrochemical system. Non-limiting examples include batteries, power grids, regenerative power supplies (e.g., wind power generators, photovoltaic cells, tidal energy generators), generators, photovoltaic cells, wind power generators, or other energy sources and the like. The power source can include one or more such power supplies (e.g., batteries and a photovoltaic cell). In a particular embodiment, the power supply can be one or more photovoltaic cells. In some cases, an electrochemical system may be constructed and arranged to be electrically connectable to and able to be driven by a photovoltaic cell (e.g., the photovoltaic cell may be the voltage or power source for the system). Photovoltaic cells include a photoactive material, which absorbs and converts light to electrical energy.

An electrochemical system may be combined with additional electrochemical system to form a larger device or system. This may take the form of a stack of devices or subsystems (e.g., fuel cell and/or electrolytic device and/or metal-air battery) to form a larger device or system. Various components of a device, such as the electrodes, power source, electrolyte, separator, container, circuitry, insulating material, gate electrode, etc. can be fabricated by those of ordinary skill in the art from any of a variety of components, as well as those described in any of those patent applications described herein. Components may be molded, machined, extruded, pressed, isopressed, infiltrated, coated, in green or fired states, or formed by any other suitable technique. Those of ordinary skill in the art are readily aware of techniques for forming components of devices herein.

Generally speaking, an electrochemical system includes two electrodes (i.e., an anode and a cathode) in contact with an electrolyte. The electrodes are electrically connected to one another; the electrical connection can, depending on the intended use of the system, include a power source (when the desired electrochemical reactions require electrical energy) or an electrical load (when the desired electrochemical reactions produce electrical energy). An electrochemical system can be used for producing, storing, or converting chemical and/or electrical energy.

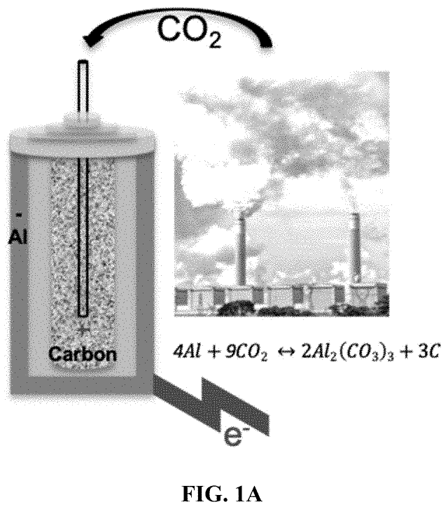

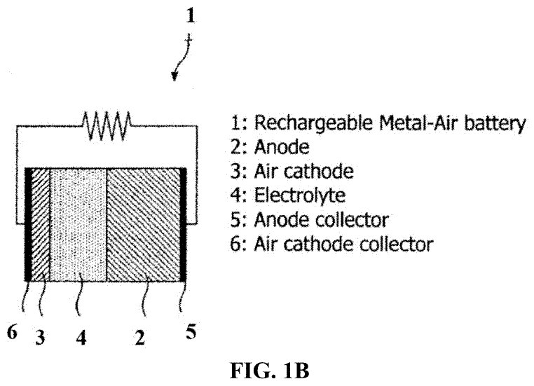

FIG. 1B schematically illustrates a rechargeable metal-air battery 1, which includes anode 2, air cathode 3, electrolyte 4, anode collector 5, and air cathode collector 6. Electrodes (anode 2 and air cathode 3 can each individually include a catalytic material); in particular, in the configuration shown, electrolyte 4 can include the redox mediator for catalyst effective for enhanced kinetics and charging efficiency. The air contains a redox active material that is constrained in the battery, for example, oxygen or carbon dioxide. The anode and cathode can be separated by a separator material. The separator material can be a porous polymer or a fibrous mat, or a combination thereof. The components can be contained in a housing, which can have one or more ports for entry and exit of a gas.

The systems described herein can be used to sequester carbon dioxide. A method of sequestering carbon dioxide can include applying a voltage across an anode and a cathode, the anode including a metal, the cathode including a carbon material, and an electrolyte including a redox mediator in contact with the anode and the cathode, in the presence of carbon dioxide to produce a reduced carbon dioxide material. The process incorporates carbon dioxide into a structure by reducing carbon dioxide to a form of carbon such as carbon monoxide, formic acid (or formate) or a hydrocarbon (or substituted hydrocarbon) or a metal-carbon complex. The reduced carbon dioxide product can be an unidentified reduces species that can be reversibly oxidized.

The battery described herein can prove electric power, and can be rechargeable as described herein. The recharging can take place through carbon dioxide sequestration into the battery.

Further details of devices and systems, including details of electrode construction, are known in the art. In this regard, see, for example, US Patent Application Publication No. 2009/0068541, which is incorporated by reference in its entirety.

An electrochemical system can include a first electrode and a second electrode; and an electrolyte in contact with the first electrode and the second electrode; wherein the second electrode includes a redox mediator. The redox mediator can be a material that facilitates reduction of carbon dioxide. The redox mediator can include a halide, for example, bromide, iodide or combinations thereof.

The anode can include aluminum, sodium, magnesium, aluminum, zinc, calcium, copper or iron. In certain circumstances, the anode can include aluminum.

The cathode can include a conductive carbon material. The conductive carbon material can include graphene, graphite, carbon black, carbon fibers, carbon microfibers, carbon nanomaterials, carbon nanotubes, multi-walled nanotube carbon, single walled carbon nanotubes, biotemplated carbon materials, molecular templated multi-walled nanotube carbon or biotemplated single walled carbon nanotubes.

Each of the anode and the cathode can include other inert metals, for example, platinum, palladium, gold, or silver.

The electrolyte can include a salt, such as an organic salt, for example, an imidazolium chloride. The electrolyte can include a redox mediator, for example, an iodide salt or a bromide salt. The iodide or bromide can be a salt, for example, a quaternary ammonium iodide or a quaternary ammonium bromide salt, or a metal iodide or metal bromide, for example, aluminum iodide or aluminum bromide.

In this work, an Al—CO₂ battery that is rechargeable and can deliver high capacity and high energy was developed. The battery utilizes an aluminum metal anode, a biological inspired microporous carbon fiber cathode and an ionic liquid electrolyte containing AlCl₃/1-ethyl-3-methyl imidazolium chloride (molar ratio 1.3:1) with 0.05 M AlI₃ as the redox mediator. Al—CO₂ cells with this design are shown to achieve excellent rechargeability with less than 50 mV overpotential and over 95% energy efficiency between the charge and discharge cycles. Reversible storage capacity of over 500 mAh/g based on the carbon mass on the cathode over 13^{th} cycles is reported. Moreover, an ultra-high energy density of 9.93 Wh/g and specific capacity of 9411 mAh/g can be achieved when performing a full discharge at 100% CO₂ gas environment, which is 39 times higher than current lithium ion batteries. Importantly, a high energy density of 0.91 Wh/g and specific capacity of 901 mAh/g can still be reached when the cell is discharged in a mimic exhaust gas of power plant containing 5% CO₂ and 20% 02 balanced nitrogen. This indicates the cell can capture and convert CO₂ directly through exhaust gas, generate and store electricity, reducing CO₂ release to the environment from the origin. The fundamental reaction mechanism of the Al—CO₂ batteries is studied using spectroscopic and electrochemical tools at the cathode during the charge and discharge processes. Notably, the high performance of the Al—CO₂ originates from at least three sources that are closely related to the addition of AlI₃:

1. Iodine can serve as redox mediator that can reversibly capture and release CO₂ at the cathode;

2. AlI₃ as the electrolyte additive can mitigate intercalation and reaction between AlₓCl_{y}⁻;

3. The addition of AlI₃ reduces the interfacial resistances and overpotential of the battery.

Altogether, a rechargeable Al—CO₂ battery has been developed that can capture/convert CO₂ directly from the power plant and generate/storage energy at the same times, which can benefit both energy and environmental applications.

FIG. 1A shows an architecture of a secondary Al—CO₂ electrochemical cell where CO₂ emitted from power plant is concentrated or converted to solid products.

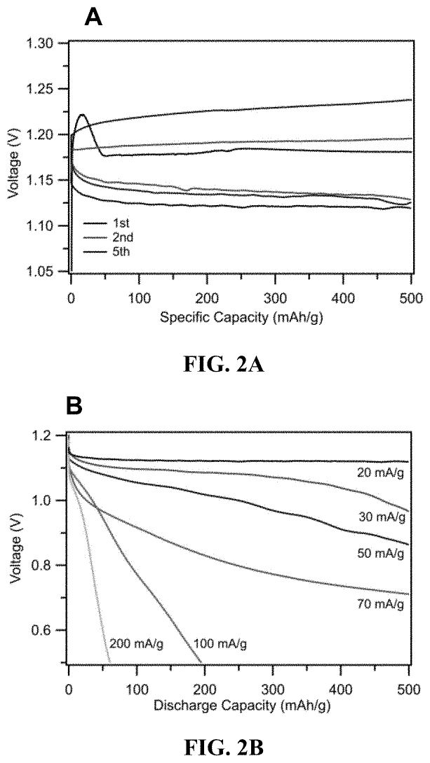

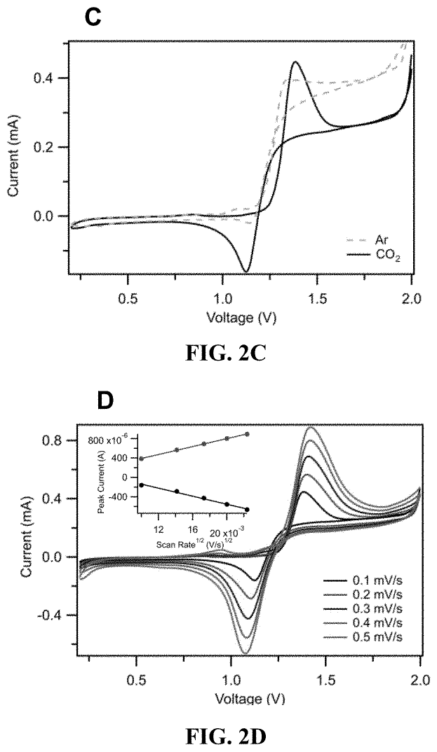

FIGS. 2A-2D show electrochemical performance of secondary Al—CO₂ batteries using molecular templated MWNT carbon (RFN-MWNT) as the cathode. FIG. 2A shows galvanostatic discharge/charge curves of the Al—CO₂ battery at a current density of 20 mA/g (carbon) and a 500 mAh/g (carbon) capacity cutoff using 1.3 AlCl₃/1-ethyl-3-methylimidizaloium chloride electrolyte (1.3 AlCl₃/IL) plus 0.05 M AlI₃. FIG. 2B shows galvanostatic discharge curves at different current densities. FIG. 2C shows cyclic voltammogram (CV) of the batteries performed in Ar and CO₂ gas environment. FIG. 2D shows a CV diagram at scanning rates of 0.1, 0.2, 0.3, 0.4, or 0.5 mV/s. The inset is the linear fit of the square root of the scan rate and the peak current.

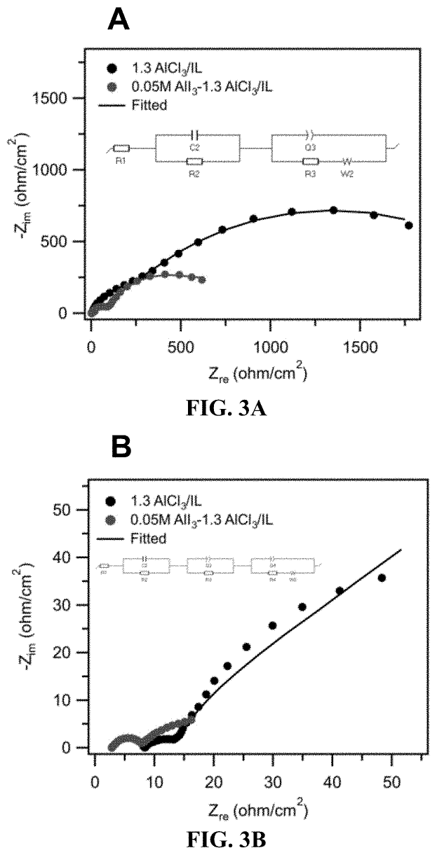

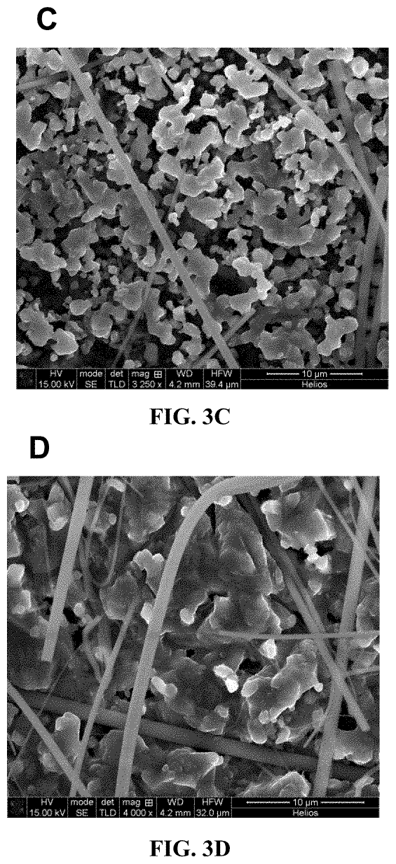

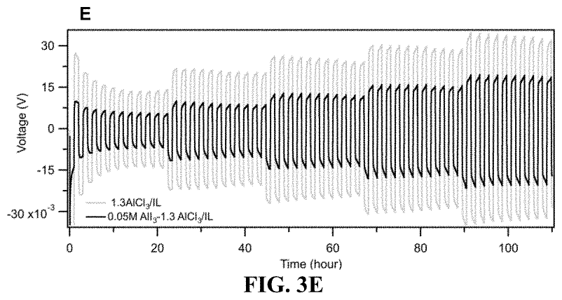

FIGS. 3A-3E show electrochemical studies of ionic liquid electrolytes in Al batteries. FIG. 3A shows electrochemical impedance spectroscopy (EIS) of symmetric Al batteries with and without 0.05 M AlI₃ in 1.3 AlCl₃/IL. FIG. 3B shows electrochemical impedance spectroscopy (EIS) of symmetric Al batteries with and without 0.05 M AlI₃ in 1.3 AlCl₃/IL after 100 hours of stripping and platting at 0.2 mA/cm². FIGS. 3C and 3D show SEM images of the surface of Al foil anode after 1000 hours of stripping and platting at 0.2 mA/cm² in (FIG. 3C) 1.3 AlCl₃/IL and (FIG. 3D) 0.05 M AlI₃+1.3 AlCl₃/IL electrolytes. FIG. 3E shows rate performance of symmetric Al batteries at current densities of 0.2, 0.3, 0.4, 0.5, or 1 mA/cm² using 1.3 AlCl₃/IL with and without 0.05 M AlI₃ electrolytes.

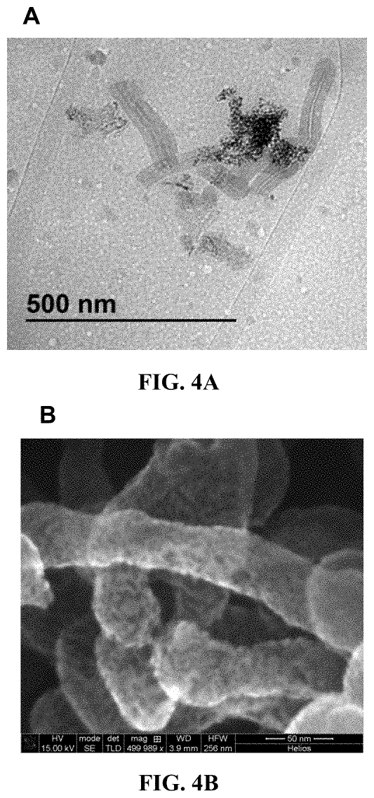

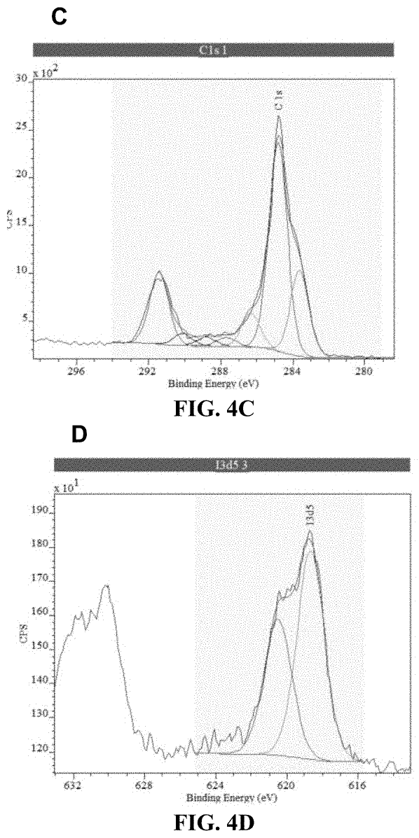

FIGS. 4A-4D show reaction mechanism of Al—CO₂ batteries in ionic liquid electrolytes. Cryo-TEM image (FIG. 4A) and SEM image (FIG. 4B) of the RFN-MWNT cathode after 10 cycles of galvanostatic charge and discharge at a current density of 20 mA/g are shown. XPS spectra of (FIG. 4C) C1s and (FIG. 4D) I3d on the surface of RFN-MWNT cathode after 10 cycles of galvanostatic cycling are shown.

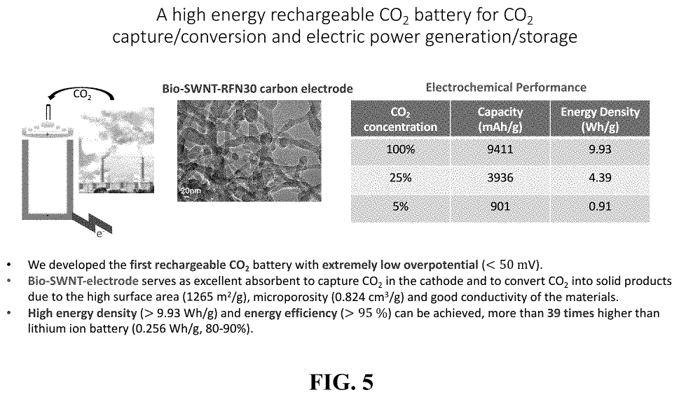

FIG. 5 summarizes a high energy rechargeable CO₂ battery for CO₂ capture/conversion and electric power generation/storage can be produced. The rechargeable CO₂ battery can have a capacity of greater than 5000 mAh/g, greater than 6000 mAh/g, greater than 7000 mAh/g, greater than 8000 mAh/g, or greater than 9000 mAh/g. The rechargeable CO₂ battery can have an energy density of greater than 4 Wh/g, greater than 64 Wh/g, greater than 8 Wh/g, or greater than 9 Wh/g. The rechargeable CO₂ battery can have an energy efficiency of greater than 90%, or greater than 95%.

The rechargeable CO₂ battery can have an extremely low overpotential (<50 mV). A Bio-SWNT-electrode can serve as excellent absorbent to capture CO₂ in the cathode and to convert CO₂ into solid products due to the high surface area (1265 m²/g), microporosity (0.824 cm³/g) and good conductivity of the materials. The rechargeable CO₂ battery can have a high energy density (>9.93 Wh/g) and energy efficiency (>95%), more than 39 times higher than lithium ion battery (0.256 Wh/g, 80-90%).

Battery cycling experiments are described below.

Cell assembly and testing: Home-made Swagelok cells were assembled using Al metal foil as the anode, glass fiber membranes as the separator, carbon-based electrode as the cathode, and 200 μL of electrolyte (1.3AlCl₃/1-ethyl-3-methylimidizalium with 0.05 M AlI₃ as the redox mediator). Cell assembly was carried out in an argon-filled glovebox (MBraun Labmaster). The room-temperature cycling characteristics of the cells were evaluated under galvanostatic conditions using Land battery testers, and electrochemical processes in the cells were studied by cyclic voltammetry and impedance spectroscopy using a Biologic VMP-3 potentiostat. Electrochemical impedance was measured between 200 kHz and 0.1 Hz with a perturbation amplitude of 10 mV on a pristine cell, as well as cells cycled at 50 mA g-1 in 1-3 V for 10 or 100 cycles. The equivalent circuit model was fitted using EC-Lab software

Post-electrochemical treatment: both cathode and anode were harvested after electrochemical measurements by disassembling the coin cells. The electrodes were washed with acetonitrile at least three times to remove the excess electrolyte salt and dried under a vacuum chamber. All procedures were carried out in an argon-filled glovebox to avoid air oxidation.

Physical characterization: SEM-EDX was performed using a Helios Nanolab 600 dual beam focused ion beam milling system and a JEOL 6700 microscope. TEM and HRTEM images were acquired with a JEOL 2100 FEG microscope operating at 200 kV. XPS was performed using a Physical Electronics Versaprobe II spectrometer with an Al Kα (1486.6 eV) photon source and a 23.5 eV pass energy. Peak deconvolution was performed using CasaXPS software with a Shirley background. Pristine nickel phosphide nanofoam spectra were charge-corrected using the 284.8 eV peak in the adventitious carbon is region (C1s).

Method of Synthesis of M13-Phage Templated Novel Graphenic Nanowire (Bio-CNF) Materials

100 mL solution contains phage of 3.2×10¹³ was stirred >1 hour at room temperature, then 10%×30 μL Ethylene diamine solution and 1.33 mL of 1M resorcinol ethanol solution were added of phage solution while stirring; add 0.1M×240 μL Cu(NO₃)₂.2.5H₂O solution followed by adding of 0.8 mL of 10% formaldehyde to the solution, then incubated at 80° C. for at least 6 hours. On completion, the nanofibers were collected by filtration then washed with water and ethanol, then dried by a lyophilizer. Then dried precursor nanofibers were heated to temperatures of 850 to 1100° C. in flowing argon (100 sccm) for at least 2 hours.

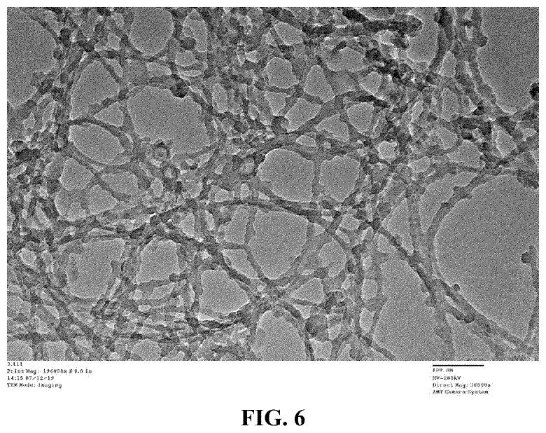

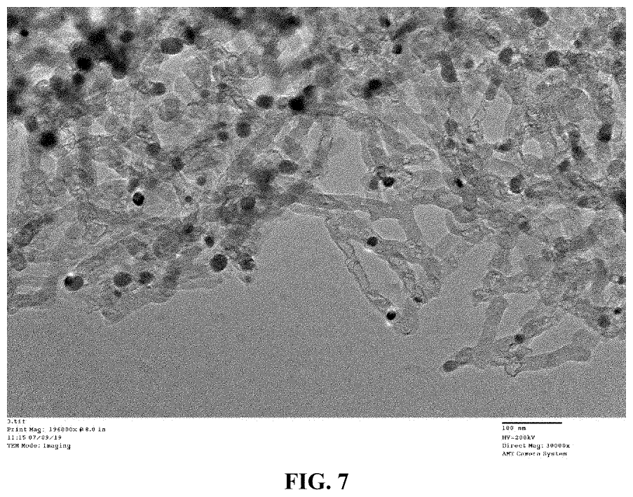

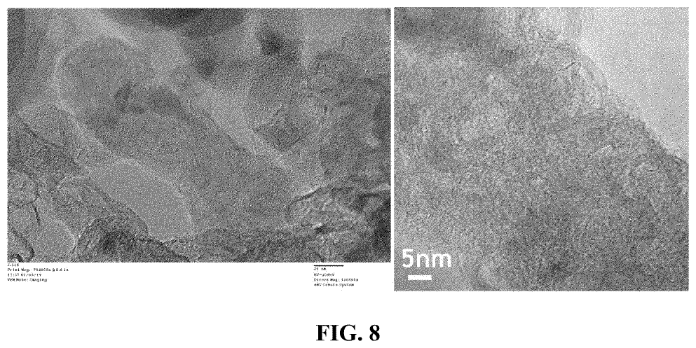

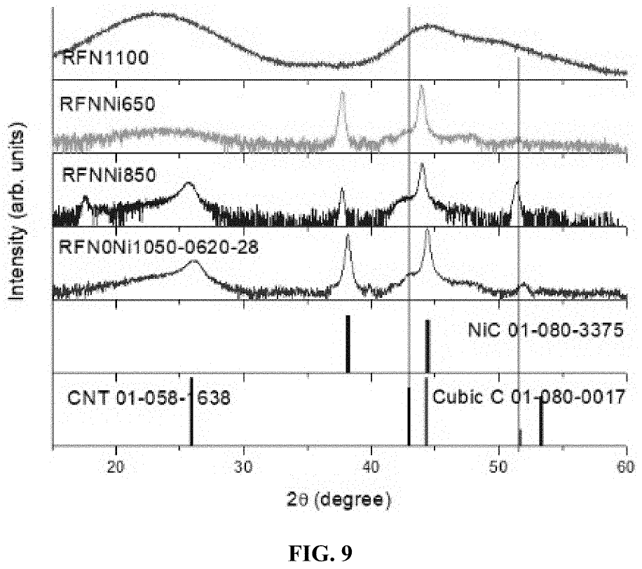

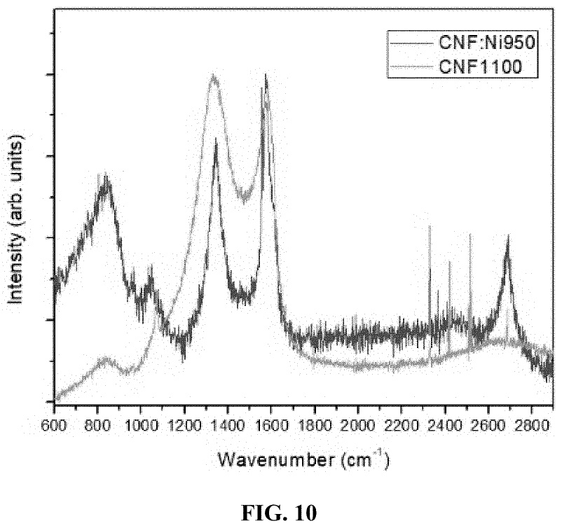

The Cu(NO₃)₂ could be replaced by other transition metal (Fe, Co, Ni, Mo, Ru) salt, we have demonstrated using nickel acetate as Ni source to synthesize graphenic nanowire materials. The novel graphenic nanowire materials consist of one-dimensional close packed nanosized multiwalled carbon spheres, with highly ordered assemble carbon atoms. FIG. 6 shows the M13 phage templated resorcinol-formaldehyde which incorporated with transition metals (Ni) as the precursors for novel graphenic nanowire materials. FIGS. 7 and 8 show the morphologies of novel graphenic nanowire materials. The main X-ray diffraction patterns of graphenic nanowires appeared at the same to carbon nanotubes (CNT) of graphene. We further studied Raman spectrum of graphenic nanowire and compared them with the carbon nanofibers made with phage templated resorcinol-formaldehyde but without transition metal as catalyst, both D and G band of graphenic nanowires dramatically narrowed and the ratio of band height of G to D increased compared with the one without nickel catalyst. Both Raman and XRD results suggested the carbon atoms are well orderly aligned (crystallized) in the materials (FIGS. 9 and 10). Thus, our novel graphenic nanowire materials may have improved surface area to the multiwalled CNT, and better conductivity than the common carbon black. One application of these novel graphenic nanowire materials is working as the conductive catalytic electrode.

More specifically, FIG. 6 shows a TEM image of M13 phage templated resorcinol-formaldehyde with incorporation of nickel in the wires. FIG. 7 a TEM image of templated novel graphenic nanowire materials including nickel (bio-CNF:Ni) synthesized at 1000° C. FIG. 8 shows high resolution TEM images of bio-CNF:Ni synthesized at 1000° C. showing the wirelike-graphenic carbon nanostructures. FIG. 9 show XRD patterns of bio-CNF:Ni synthesized at different temperature through M13 phage templated resorcinol-formaldehyde with incorporation of nickel as the catalyst, and as a comparison, the one without nickel also shown in the upper graph. FIG. 10 show comparison of the Raman spectra from bio-CNF:Ni and bio-CNF.

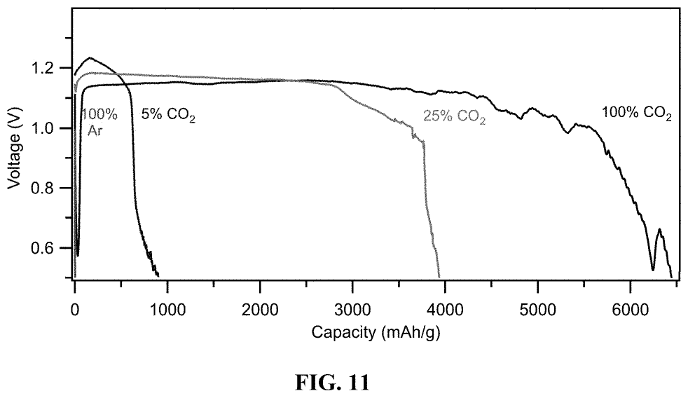

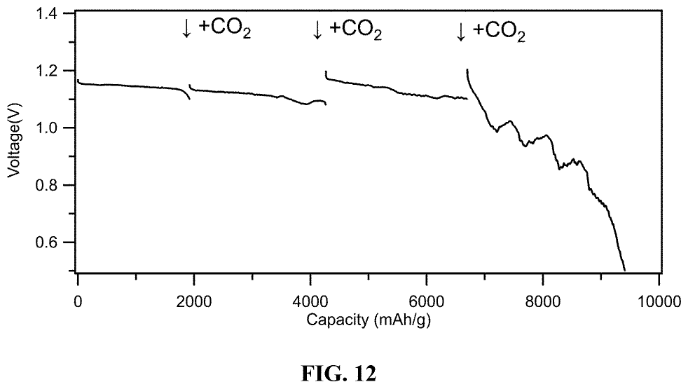

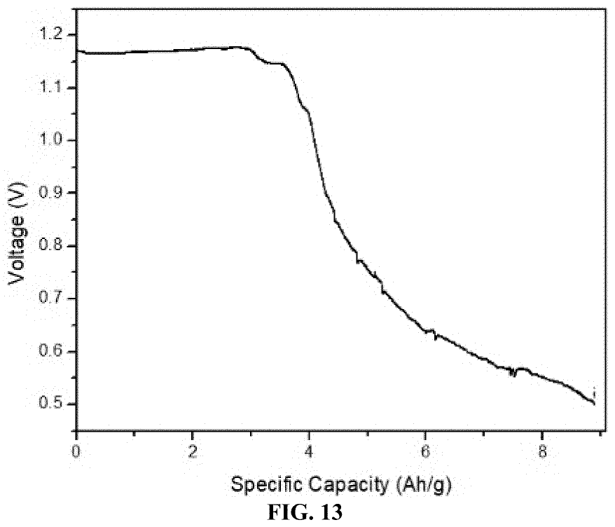

FIG. 11 shows the first discharge performance of Al—CO₂ battery when filled with different concentrations of CO₂. The capacity here is limited by the quantities of CO₂ in the batteries. FIG. 12 shows the first discharge performance of Al—CO₂ battery with refilling CO₂ and the capacity (9.41 Ah/g) is larger than the one without refill CO₂ gas (6.4 Ah/g) which shown in FIG. 11. FIG. 13 shows the voltage of an Al-Air battery that the battery is open to the air (containing 21% O₂ and 0.04% CO₂).

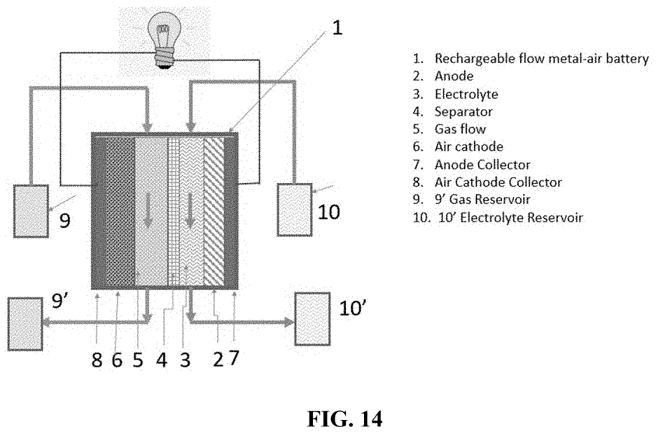

Based on the above experimental results, it is obviously the capacity of Ai-CO₂ battery depends on the surface area of carbon electrode as well as the CO₂ quantity in the battery, for it is continually consumed during the discharging process, insufficient CO₂ in the battery makes battery not able to work at full capacity. The first way to deal with the issue is to let the battery open to dry air, the performance of the first Al-air battery is shown in FIG. 12. The other way is let the low CO₂ concentration air (mixing gas) continue feed into battery during the battery discharging process. The CO₂ will be captured and consumed to generate electricity. A flow battery is shows in FIG. 14. The battery can be rechargeable. FIG. 14 depicts a structure and operation of the flow battery that involved in this type battery. FIG. 14 shows a rechargeable flow metal-air battery 1 that includes an anode 2 that is adjacent to an anode collector 7. A separator 4 provides electrical insulation between the anode 2 and air cathode 6. Air cathode 6 can be adjacent to an air cathode collector 8. Electrolyte 3 contacts anode 2 and cathode 6. Electrolyte can flow between electrolyte reservoirs 10 and 10′. Gas flow 5 can pass through the cathode side of the battery. Gas flow can be provided from a variety of sources, for example, between gas reservoirs 9 and 9′. In this flow battery, the first working circumstance is the flowing of the CO₂ gas or the air mixed with CO₂ through the battery, from the gas source/reservoir 9 to reservoir 9′, this enable the sufficient supply of CO₂ for the working process of battery. Another case is the electrolyte flows through the battery, from the electrolyte reservoir 10 to reservoir 10′. Electrolyte reservoir 10 to reservoir 10′ could be connected or the same. The third working case is that flowing the mixture or dispersion of air cathode materials mixed with electrolyte and CO₂ gas through the battery. In one example, the gas inlet can connect to CO₂ source and let the gas containing CO₂ pass though battery, the CO₂ and O₂ in the gas could act as working gas electrode involved in the discharging process. The rechargeable flow metal-air battery can include a redox mediator.

Other embodiments are within the scope of the following claims.

What is claimed is:

1. A battery comprising:
a housing containing:
a cathode including a carbon material;
an anode including a metal;
a separator between the cathode and the anode; and
an electrolyte contacting the anode and the cathode, the electrolyte including a redox mediator.

2. The battery of claim 1, wherein the housing includes one or more ports for entry and exit of a gas.

3. The battery of claim 1, wherein the metal includes sodium, magnesium, aluminum, zinc, calcium, copper or iron.

4. The battery of claim 1, wherein the carbon material includes a conductive carbon material.

5. The battery of claim 4, wherein the conductive carbon material includes graphene, graphite, carbon black, carbon fibers, carbon microfibers, carbon nanomaterials, carbon nanotubes, multi-walled nanotube carbon, single walled carbon nanotubes, biotemplated carbon materials, molecular templated multi-walled nanotube carbon or biotemplated single walled carbon nanotubes.

6. The battery of claim 1, wherein the electrolyte includes an organic salt.

7. The battery of claim 1, wherein the redox mediator includes an iodide salt or a bromide salt.

8. The battery of claim 1, wherein the battery reduces at least a portion of CO₂.

9. The battery of claim 1, wherein the battery has a capacity of greater than 7000 mAh/g, greater than 8000 mAh/g, or greater than 9000 mAh/g.

10. The battery of claim 1, wherein the battery has energy density of greater than 4 Wh/g, greater than 64 Wh/g, greater than 8 Wh/g, or greater than 9 Wh/g.

11. The battery of claim 1, wherein the anode includes aluminum and the redox mediator includes an iodide salt.

12. The battery of claim 1, wherein the battery has an energy efficiency of greater than 90%, or greater than 95%.

13. The battery of claim 1, wherein the battery is rechargeable.

14. The battery of claim 1, wherein the battery is a flow cell battery.

15. The battery of claim 1, wherein the housing includes an anode gas entry port, an anode gas exit port, an electrolyte entry port and an electrolyte exit port.

16. The battery of claim 1, further comprising an electrolyte reservoir fluidly connected to the electrolyte entry port and the electrolyte exit port.

17. A method of sequestering carbon dioxide comprising:
applying a voltage across an anode and a cathode, the anode including a metal, the cathode including a carbon material, and an electrolyte including a redox mediator in contact with the anode and the cathode, in the presence of carbon dioxide to produce a reduced carbon dioxide material.

18. A method of providing electric power comprising:
providing a battery comprising:
a housing containing:
a cathode including a carbon material;
an anode including a metal;
a separator between the cathode and the anode; and
an electrolyte contacting the anode and the cathode, the electrolyte including a redox mediator; and
discharging the battery.

19. The method of claim 18, further comprising:
recharging the battery.

20. The method of claim 19, further comprising providing carbon dioxide to the battery.
